(19) United States
(12) Patent Application Publication
(10) Pub. No.: US 2015/0097722 A1
(43) Pub. Date: Apr. 9, 2015

(54) APPARATUS AND METHOD FOR RECEIVING NAVIGATION SIGNAL

(71) Applicant: Electronics and Telecommunications Research Institute, Daejeon (KR)

(72) Inventors: Cheon Sig SIN, Daejeon (KR); Sang Uk LEE, Daejeon (KR); Jae Hoon KIM, Daejeon (KR)

(21) Appl. No.: 14/303,780

(22) Filed: Jun. 13, 2014

(30) Foreign Application Priority Data
Oct. 4, 2013 (KR) 10-2013-0118715

(51) Int. Cl. G01S 19/38; G01S 19/00

(52) U.S. Cl. CPC G01S 19/38; G01S 19/00
USPC 342/357.21; 342/357.2

(57) ABSTRACT

An apparatus for receiving a navigation signal receives a plurality of navigation signals having different available frequency bandwidths, selects a navigation signal in a band in which signal disturbance does not occur among the plurality of navigation signals, and calculates a navigation solution.

### CROSS-REFERENCE TO RELATED APPLICATION

This application claims priority to and the benefit of Korean Patent Application No. 10-2013-0118715 filed in the Korean Intellectual Property Office on Oct. 4, 2013, the entire contents of which are incorporated herein by reference.

### BACKGROUND OF THE INVENTION

(a) Field of the Invention

The present invention relates to an apparatus and a method for receiving a navigation signal. More particularly, the present invention relates to an apparatus and a method for receiving a navigation signal capable of detecting and processing disturbance of a global positioning system (GPS) signal.

(b) Description of the Related Art

Disturbance of a global positioning system (GPS) signal occurs in various forms such as when a navigation receiver is not normally operated in a GPS navigation receiving band, and when it seems that the navigation receiver is normally operated, but the navigation receiver causes an error in calculated information. The disturbance of the GPS signal generates a serious problem in fields such as a mobile communication base state, an airplane, a ship, and the like, using the GPS signal.

According to the related art, a method of detecting a GPS disturbance signal using a disturbance signal detecting circuit including a sniffer antenna, selectively connecting a plurality of band pass filters to the sniffer antenna, and selecting a corresponding bandwidth based on the detected disturbance signal to decrease strength of the disturbance of the GPS signal, in the case in which the disturbance of the GPS signal occurs, has been suggested.

In addition, an array antenna operating one central element added thereto and operated when a disturbance signal is not present in a turn-on/off form depending on whether or not a disturbance signal is present in order to remove the disturbance signal causing the disturbance of the GPS signal has been suggested.

However, a method for processing a disturbance signal using only an antenna has a disadvantage that performance is degraded when a multipath signal is present. Therefore, a technology of removing a disturbance signal by signal processing in a time domain or a frequency domain should be additionally introduced.

In order to determine a threshold, which becomes a determination criterion of a disturbance signal with respect to an input signal in connection with a frequency domain, an N-sigma scheme, or the like, has been used. However, the N-sigma scheme is additionally required a complicated calculation process. In addition, when a fixed threshold is set in order to remove disturbance signals, it is difficult to remove a disturbance signal smaller than the set threshold, a calculation procedure is complicated in changing the threshold, and additionally improved hardware is required. Further, when multi-signal disturbance is present or various kinds of radio disturbance sources are present, it is difficult to set a threshold for effectively removing all disturbance signals.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus and a method for receiving a navigation signal capable of detecting and coping with disturbance of various types of navigation signals.

An exemplary embodiment of the present invention provides a method for receiving a navigation signal by an apparatus for receiving a navigation signal. The method for receiving a navigation signal includes: receiving a plurality of navigation signals having different available frequency bandwidths; selecting a navigation signal in a band in which signal disturbance does not occur among the plurality of navigation signals; and calculating a navigation solution using the navigation signal in which the signal disturbance does not occur.

The selecting may include: selecting one of the plurality of navigation signals; determining whether or not the signal disturbance has occurred from the selected navigation signal; and selecting a navigation signal in a different band from that of the selected navigation signal when it is determined that the signal disturbance has occurred from the selected navigation signal.

The selecting of one of the plurality of navigation signals may include passing the plurality of navigation signals through a band pass filter passing only signals in a frequency band that is the same as that of the selected navigation signal therethrough.

The determining may include: converting the selected navigation signal into a digital signal depending on a predetermined quantization bit; converting the digital signal into a signal in a frequency domain; and determining whether or not the signal disturbance has occurred from the signal in the frequency domain.

The determining of whether or not the signal disturbance has occurred from the signal in the frequency domain may include: detecting at least one of parameters of a signal strength, a Doppler frequency change value, a code phase change value, and a carrier phase change value from the signal in the frequency domain; and comparing the at least one detected parameter with a predetermined threshold to determine whether or not the signal disturbance has occurred.

The determining of whether or not the signal disturbance has occurred from the selected navigation signal may further include: extracting a navigation message from the selected navigation signal; and determining whether or not the signal disturbance has occurred from information in the navigation message.

The determining of whether or not the signal disturbance has occurred from the information in the navigation message may include: comparing the information in the navigation message with information of a pre-stored navigation message; and determining whether or not the signal disturbance has occurred from information in which a change occurs.

The converting of the selected navigation signal into the digital signal may include adjusting the quantization bit depending on whether or not the signal disturbance has occurred.

The selected navigation signal may include a global positioning system (GPS) navigation signal

Another exemplary embodiment of the present invention provides an apparatus for receiving a navigation signal. The apparatus for receiving a navigation signal includes a receiving antenna, a filter group unit, and a controller. The receiving antenna receives a plurality of navigation signals having different available frequency bandwidths. The filter group unit includes a plurality of band pass filters passing signals having different frequency bandwidths therethrough, selects a first band pass filter among the plurality of band pass filters, and passes the plurality of navigation signals through the selected first band pass filter. The controller controls the filter group unit to select a second band pass filter different from the first band pass filter when it is determined that signal disturbance has occurred from a navigation signal output from the first band pass filter.

The apparatus for receiving a navigation signal may further include a fast Fourier transform (FFT) unit and a signal disturbance determining unit. The FFT unit may convert the navigation signal output from the first band pass filter into a signal in a frequency domain. The signal disturbance determining unit may determine whether or not the signal disturbance has occurred from the signal in the frequency domain.

The signal disturbance determining unit may detect at least one of parameters of a signal strength, a Doppler frequency change value, a code phase change value, and a carrier phase change value from the signal in the frequency domain, and compare the at least one detected parameter with a threshold to determine whether or not the signal disturbance has occurred.

The apparatus for receiving a navigation signal may further include a navigation message extractor and a signal disturbance determining unit. The navigation message extractor may extract a navigation message from the navigation signal output from the first band pass filter. The signal disturbance determining unit may determine whether the signal disturbance has occurred using information of the navigation message.

The apparatus for receiving a navigation signal may further include an adaptive analog to digital converter (ADC). The adaptive ADC may convert the navigation signal output from the first band pass filter into a digital signal depending on a quantization bit. The controller may control the quantization bit depending on whether or not the signal disturbance has occurred.

The apparatus for receiving a navigation signal may further include a navigation solution calculator. The navigation solution calculator may calculate a navigation solution from the navigation signal when it is determined that the signal disturbance has not occurred from the navigation signal output from the first band pass filter.

The controller may instruct the filter group unit to select the second band pass filter when a carrier to noise power density of the navigation signal output from the first band pass filter exceeds a predetermined threshold.

### BRIEF DESCRIPTION OF THE DRAWINGS

FIG. 1 is a drawing showing an apparatus for receiving a navigation signal according to an exemplary embodiment of the present invention.

FIG. 2 is a drawing showing a filter group unit shown in FIG. 1.

FIG. 3 is a drawing showing a signal disturbance determining unit shown in FIG. 1.

FIG. 4 is a flowchart showing a method for receiving a navigation signal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Hereinafter, an apparatus and a method for receiving a navigation signal according to an exemplary embodiment of the present invention will be described in detail with reference to the accompanying drawings.

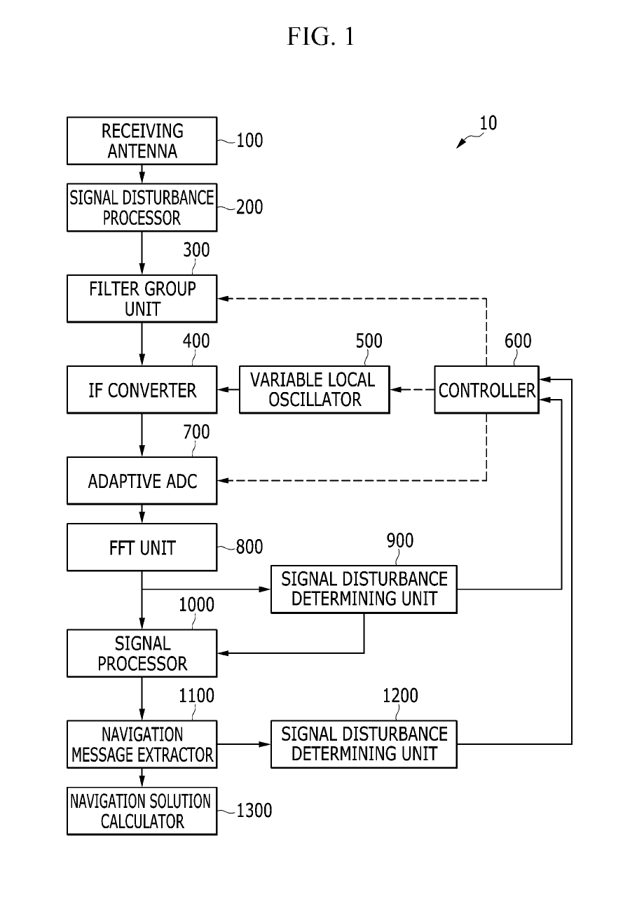

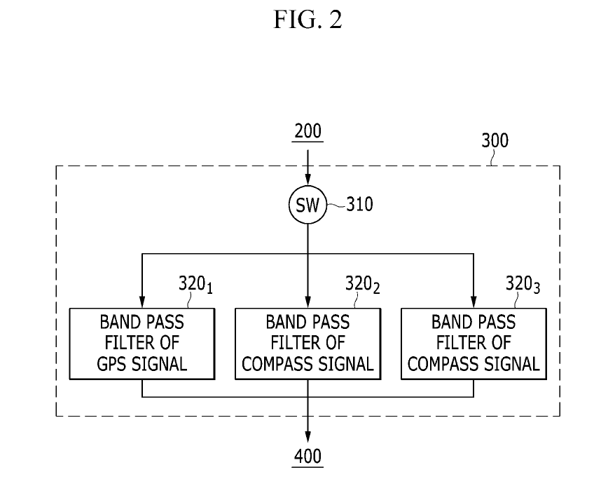

FIG. 1 is a drawing showing an apparatus for receiving a navigation signal according to an exemplary embodiment of the present invention, and FIG. 2 is a drawing showing a filter group unit shown in FIG. 1.

Referring to FIG. 1, an apparatus 10 for receiving a navigation signal includes a receiving antenna 100, a signal disturbance processor 200, a filter group unit 300, an intermediate frequency (IF) converter 400, a variable local oscillator 500, a controller 600, an adaptive analog to digital converter (ADC) 700, a fast Fourier transform (FFT) unit 800, a signal disturbance determining unit 900, a signal processor 1000, a navigation message extractor 1100, a signal disturbance determining unit 1200, and a navigation solution calculator 1300. The apparatus 10 for receiving a navigation signal may be implemented by various electronic devices such as a personal computer, a mobile communication terminal, a navigation device, a personal digital assistant (PDA), or the like.

The receiving antenna 100 receives a wideband radio frequency (RF) signal so that it may receive all of the navigation signals provided by a global navigation satellite system (GNSS). A typical example of the GNSS may include a global positioning system (GPS) of the United States, a global navigation satellite system (GLONASS) of Russia, a Galileo system of Europe, a COMPASS, which is a navigation satellite system of China, and the like. Hereinafter, only the GPS, the GLONASS, and the COMPASS will be mentioned as the GNSS for convenience of explanation.

The signal disturbance processor 200 excludes or alleviates and outputs disturbance signals from the GNSS navigation signals received through the receiving antenna 100. The signal disturbance processor 200 may use an antenna beam forming method or a method of nulling the disturbance signals in order to exclude or alleviate the disturbance signals.

Referring to FIG. 2, the filter group unit 300 includes a switch 310 and a plurality of band pass filters, for example, three band pass filters 320₁, 320₂, and 320₃.

The switch 310 performs switching to a band pass filter corresponding to a received GNSS navigation signal among the band pass filters 320₁, 320₂, and 320₃ depending on switching control signals of the controller 600 to connect the band pass filter corresponding to the received GNSS navigation signal to the signal disturbance processor 200. The band pass filter selected by the switch 310 band pass filters the received GNSS navigation signal. The band pass filter 320₁ passes only a GPS signal band from the received GNSS navigation signals therethrough, the band pass filter 320₂ passes only a GLONASS signal band from the received GNSS navigation signals therethrough, and the band pass filter 320₃ passes only a COMPASS signal band from the received GNSS navigation signals therethrough.

Again referring to FIG. 1, the IF converter 400 mixes a frequency sent by the variable local oscillator 500 and a frequency of the GNSS navigation signal output from the filter group unit 300 in order to down-convert the GNSS navigation signal output from the filter group unit 300, which is an RF signal, into an IF signal.

The variable local oscillator 500 varies a local oscillation frequency depending on a control command of the controller 600, and sends the varied local oscillation frequency to the IF converter 400.

The controller 600 determines whether signal disturbance has occurred in the GNSS navigations signal based on a determination result of the signal disturbance determining unit 900 and a determination result of the signal disturbance determining unit 1200, and adjusts quantization bits of the adaptive ADC 700 to cope with the signal disturbance in the case in which the signal disturbance occurs. The number of quantization bits is adjusted such that capability to cope with the signal disturbance may be improved. Since the capability to cope with the signal disturbance is improved by about 6 dB per quantization bit, in the case in which the number of quantization bits is changed from two to three, the capability to cope with electric wave disturbance may be improved by 6 dB.

In addition, the controller 600 may control the filter group unit 300 and the IF converter 400 to use a GNSS navigation signal provided by another navigation satellite system when strength of the signal disturbance exceeds a preset threshold. The controller 600 may control the filter group unit 300 and the IF converter 400 to preferentially use a GPS navigation signal provided by the GPS rather than using GNSS navigation signals provided by all navigation satellite systems in order to extend a lifespan of the apparatus 10 for receiving a navigation signal, and may control the filter group unit 300 and the IF converter 400 to use a navigation signal provided by the GLONASS or the COMPASS when strength of signal disturbance of the GPS navigation signal exceeds a predetermined threshold. In this case, power consumption may be decreased as compared with a method of using all GNSS navigation signals that may be used in the apparatus 10 for receiving a navigation signal.

The adaptive ADC 700 converts the IF signal output from the IF converter 400 from an analog form into a digital form depending on the quantization bits. Here, the adaptive ADC 700 may determine the quantization bits depending on control of the controller 600. For example, the controller 600 may set the quantization bits to be different from each other depending on whether or not the signal disturbance has occurred in the GNSS navigation signal. The controller 600 may set the quantization bits of the adaptive ADC 700 to 8 bits in the case in which the signal disturbance does not occur in the GNSS navigation signal, and set the quantization bits of the adaptive ADC 700 to 24 bits in the case in which the signal disturbance occurs in the GNSS navigation signal, thereby coping with the signal disturbance.

The FFT unit 800 performs fast Fourier transform (FFT) on the digital IF signal output from the adaptive ADC 700 to convert the digital IF signal into a signal in a frequency domain and outputs the converted signal, in order to analyze a spectrum of the digital IF signal.

The signal disturbance determining unit 900 calculates at least one parameter for determining the signal disturbance based on the signal in the frequency domain output from the FFT unit 800, and determines whether or not the signal disturbance has occurred based on the at least one calculated parameter. The signal disturbance determining unit 900 transfers a determination result regarding whether or not the signal disturbance has occurred to the controller 600.

The signal processor 1000 performs a navigation signal processing function using the digital IF signal output from the adaptive ADC 700. The GNSS navigation signal includes a pseudo-range, a carrier phase, an instantaneous carrier Doppler frequency, and a navigation message. The signal processor 1000 calculates a pseudo-range between a satellite and the apparatus 10 for receiving a navigation signal using navigation information such as the pseudo-range, the carrier phase, the instantaneous carrier Doppler frequency, and the like, from the digital IF signal output from the adaptive ADC 700, and performs signal tracking for calculating a more accurate value for the navigation signal.

The navigation message extractor 1100 extracts a navigation message from the digital IF signal output from the adaptive ADC 700, and transfers the extracted navigation message to the signal disturbance determining unit 1200. The navigation message includes a time and an error of a clock mounted in the satellite, state information of the satellite, orbit information and states (almanac) and ephemeris related to all satellites, a coefficient for correcting an error, and the like.

The signal disturbance determining unit 1200 stores information of the navigation message or a predetermined time in order to perform a function of detecting whether a change in the information of the navigation message is present. Here, the store information of the navigation information is information extracted from a navigation message of a normal GNSS navigation signal in which the signal disturbance does not occur. Here, the signal disturbance determining unit 1200 may update only changed data except for overlapped data in order to decrease a load amount due to the storage of the information. In addition, the signal disturbance determining unit 1200 may store the information for a predetermined time, and may erase old information and update new information when a capacity of a memory is reached, in consideration of a limitation of the memory.

The signal disturbance determining unit 1200 compares input information of the navigation message of the GNSS navigation signal with the stored information of the navigation message to determine whether or not the signal disturbance has occurred. The signal disturbance determining unit 1200 may determine whether or not the signal disturbance has occurred depending on the amount of changed information as a comparison result. The signal disturbance determining unit 1200 determines that the signal disturbance has occurred when the amount of changed information exceeds a threshold for determining that the signal disturbance has occurred in view of the navigation message. The signal disturbance determining unit 1200 transfers a determination result for whether or not the signal disturbance has occurred to the controller 600.

The navigation solution calculator 1300 calculates a navigation solution using the normal GNSS navigation signal and the navigation message. The navigation solution may include information on a position, a moving speed, a time, and the like, of the apparatus 10 for receiving a navigation signal.

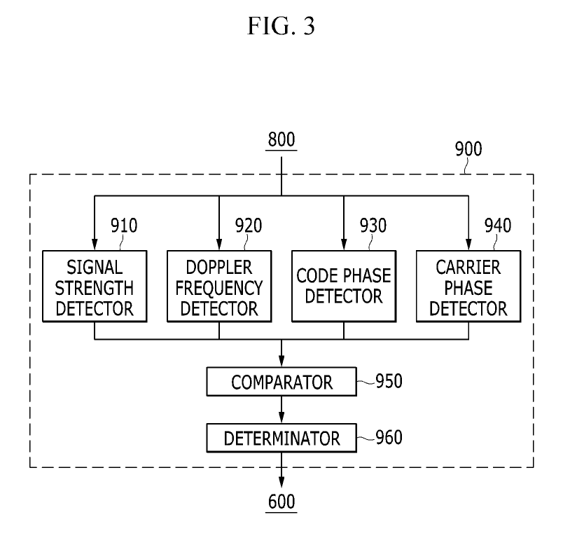

FIG. 3 is a drawing showing a signal disturbance determining unit shown in FIG. 1.

Referring to FIG. 3, the signal disturbance determining unit 900 includes a signal strength detector 910, a Doppler frequency detector 920, a code phase detector 930, a carrier phase detector 940, a comparator 950, and a determinator 960.

The signal strength detector 910 detects signal strength from the signal in the frequency domain output from the FFT unit 800. The signal strength may include a carrier to noise power density (C/No).

The Doppler frequency detector 920 detects a change in a Doppler frequency using the signal in the frequency domain output from the FFT unit 800.

The code phase detector 930 detects a change in a code phase using the signal in the frequency domain output from the FFT unit 800.

The carrier phase detector 940 detects a change in a carrier phase using the signal in the frequency domain output from the FFT unit 800.

The comparator 950 compares parameters each detected by the signal strength detector 910, the Doppler frequency detector 920, the code phase detector 930, and the carrier phase detector 940 with predetermined thresholds, respectively, and transfers parameters exceeding the threshold values to the determinator 960.

The determinator 960 determines whether or not the signal disturbance has occurred from a comparison result of the comparator 950. For example, the determinator 960 may determine that the signal disturbance has occurred in the case in which the number of parameters exceeding the thresholds is a predetermined number or more.

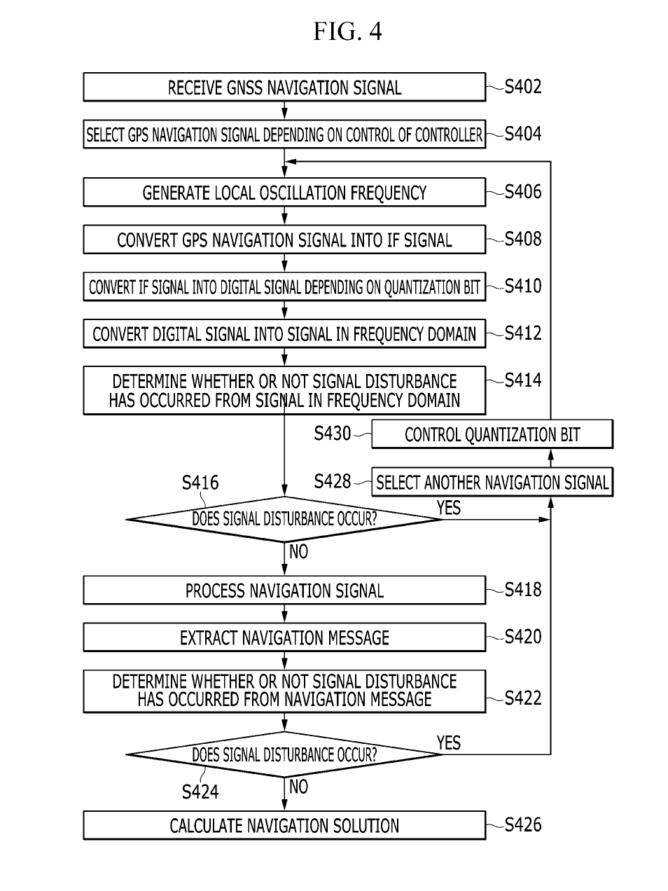

FIG. 4 is a flowchart showing a method for receiving a navigation signal according to an exemplary embodiment of the present invention.

Referring to FIG. 4, the receiving antenna 100 receives all GNSS navigation signals provided by the GNSS (S402).

First, the controller 600 controls the filter group unit 300 and the variable local oscillator 500 to process the GNSS navigation signals including the GPS signal.

The filter group unit 300 selects the GNSS navigation signal in a GPS signal band, that is, the GPS navigation signal, depending on control of the controller 600 (S404). The filter group unit 300 transfers the GNSS navigation signals to the band pass filter 320₁ passing only the GPS signal band therethrough among the band pass filters 320₁, 320₂, and 320₃ depending on the control of the controller 600. Only the GPS navigation signal may be output among the GNSS navigation signals by the band pass filter 320₁.

The variable local oscillator 500 generates a local oscillation frequency for converting the GPS navigation signal, which is the RF signal, into the IF signal depending on the control of the controller 600, and outputs the generated local oscillation frequency to the IF converter 400 (S406).

The IF converter 400 converts the GPS navigation signal output from the filter group unit 300, which is the RF signal, into the IF signal using the local oscillation frequency of the variable local oscillator 500 (S408).

The adaptive ADC 700 converts the IF signal output from the IF converter 400 from an analog form into a digital form depending on the quantization bits (S410).

The FFT unit 800 performs the fast Fourier transform (FFT) on the digital IF signal output from the adaptive ADC 700 to convert the digital IF signal into the signal in the frequency domain (S412).

The signal disturbance determining unit 900 determines whether or not the signal disturbance has occurred based on the signal in the frequency domain output from the FFT unit 800 (S414), and transfers a determination result regarding whether or not the signal disturbance has occurred to the controller 600.

When it is determined by the signal disturbance determining unit 900 that the signal disturbance has not occurred (S416), the signal processor 1000 processes the GNSS navigation signal using the digital IF signal output from the adaptive ADC 700 (S418).

Since the signal disturbance may occur in view of the navigation message even though it does not occur on a spectrum, the navigation message extractor 1100 extracts the navigation message from the digital IF signal output from the adaptive ADC 700 (S420).

The signal disturbance determining unit 1200 determines whether or not the signal disturbance has occurred using information in the navigation message (S422), and transfers a determination result regarding whether or not the signal disturbance has occurred to the controller 600.

When it is determined by the signal disturbance determining unit 1200 that the signal disturbance has not occurred (S424), the navigation solution calculator 1300 calculates the navigation solution using the digital IF signal GNSS navigation signal corresponding to the received GNSS navigation signal and the navigation message (S426).

Meanwhile, when it is determined that the signal disturbance has occurred using the determination result of the signal disturbance determining unit 900 and the determination result of the signal disturbance determining unit 1200, the controller 600 adjusts the quantization bits of the adaptive ADC 700 (S430). As described above, the quantization bits of the adaptive ADC 700 are adjusted to cope with the signal disturbance.

In addition, when it is determined that the signal disturbance has occurred as the determination result of the signal disturbance determining unit 900 and the determination result of the signal disturbance determining unit 1200, the controller 600 may select another GNSS navigation signal (S428). The controller 600 may cope with the signal disturbance of the GPS navigation signal by adjusting the quantization bits of the adaptive ADC 700, and may select a GNSS navigation signal of a navigation system other than the GPS when strength (for example, C/No) of the signal disturbance measured from the GPS navigation signal exceeds a predetermined signal level.

When the GNSS navigation signal of another navigation system is selected, the controller 600 may control the local oscillation frequency of the variable local oscillator 500 so as to be converted into the IF signal in accordance with the GNSS navigation signal of the other navigation system.

At least part function of an apparatus and a method for receiving a navigation signal according to an embodiment of the present invention may be implemented a hardware or a software combined with the hardware. For example, a processor such as a central processing unit (CPU), other chipset, or a microprocessor may perform a function of at least one of the signal disturbance processor 200, the filter group unit 300, the IF converter 400, the variable local oscillator 500, the controller 600, the ADC 700, the FFT unit 800, the signal disturbance determining unit 900, the signal processor 1000, the navigation message extractor 1100, the signal disturbance determining unit 1200, and the navigation solution calculator 1300, and a transceiver may includes the receiving antenna 100.

According to an exemplary embodiment of the present invention, when signal disturbance occurs in an available frequency bandwidth of a GPS navigation signal, a quantization bit of an adaptive ADC is adjusted to cope with the signal disturbance. Then, when strength of the signal disturbance exceeds a predetermined signal level, a navigation signal of a navigation system other than the GPS is used, thereby making it possible to effectively cope with signal disturbance of the GPS navigation signal.

In addition, it is possible to extend a lifespan of an apparatus for receiving a navigation signal by basically using the GPS navigation signal rather than processing all available GNSS signals.

The above-mentioned exemplary embodiments of the present invention are not embodied only by an apparatus and method. Alternatively, the above-mentioned exemplary embodiments may be embodied by a program performing functions which correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for receiving a navigation signal by an apparatus for receiving a navigation signal, comprising:
receiving a plurality of navigation signals having different available frequency bandwidths;
selecting a navigation signal in a band in which signal disturbance does not occur among the plurality of navigation signals; and
calculating a navigation solution using the navigation signal in which the signal disturbance does not occur.

2. The method for receiving a navigation signal of claim 1, wherein
the selecting includes:
selecting one of the plurality of navigation signals;
determining whether or not the signal disturbance has occurred from the selected navigation signal; and
selecting a navigation signal in a different band from that of the selected navigation signal when it is determined that the signal disturbance has occurred from the selected navigation signal.

3. The method for receiving a navigation signal of claim 2, wherein
the selecting of one of the plurality of navigation signals includes passing the plurality of navigation signals through a band pass filter passing only signals in a frequency band that is the same as that of the selected navigation signal therethrough.

4. The method for receiving a navigation signal of claim 2, wherein
the determining includes:
converting the selected navigation signal into a digital signal depending on a predetermined quantization bit;
converting the digital signal into a signal in a frequency domain; and
determining whether or not the signal disturbance has occurred from the signal in the frequency domain.

5. The method for receiving a navigation signal of claim 4, wherein
the determining of whether or not the signal disturbance has occurred from the signal in the frequency domain includes:
detecting at least one of parameters of a signal strength, a Doppler frequency change value, a code phase change value, and a carrier phase change value from the signal in the frequency domain; and
comparing the at least one detected parameter with a predetermined threshold to determine whether or not the signal disturbance has occurred.

6. The method for receiving a navigation signal of claim 4, wherein
the determining of whether or not the signal disturbance has occurred from the selected navigation signal further includes:
extracting a navigation message from the selected navigation signal; and
determining whether or not the signal disturbance has occurred from information in the navigation message.

7. The method for receiving a navigation signal of claim 6, wherein
the determining of whether or not the signal disturbance has occurred from the information in the navigation message includes:
comparing the information in the navigation message with information of a pre-stored navigation message; and
determining whether or not the signal disturbance has occurred from information in which a change occurs.

8. The method for receiving a navigation signal of claim 4, wherein
the converting of the selected navigation signal into the digital signal includes adjusting the quantization bit depending on whether or not the signal disturbance has occurred.

9. The method for receiving a navigation signal of claim 2, wherein
the selected navigation signal includes a global positioning system (GPS) navigation signal.

10. An apparatus for receiving a navigation signal, comprising:
a receiving antenna receiving a plurality of navigation signals having different available frequency bandwidths;
a filter group unit including a plurality of band pass filters passing signals having different frequency bandwidths therethrough, selecting a first band pass filter among the plurality of band pass filters, and passing the plurality of navigation signals through the selected first band pass filter; and
a controller controlling the filter group unit to select a second band pass filter different from the first band pass filter when it is determined that signal disturbance has occurred from a navigation signal output from the first band pass filter.

11. The apparatus for receiving a navigation signal of claim 10, further comprising:
a fast Fourier transform (FFT) unit converting the navigation signal output from the first band pass filter into a signal in a frequency domain; and
a signal disturbance determining unit determining whether or not the signal disturbance has occurred from the signal in the frequency domain.

12. The apparatus for receiving a navigation signal of claim 11, wherein
the signal disturbance determining unit detects at least one of parameters of a signal strength, a Doppler frequency change value, a code phase change value, and a carrier phase change value from the signal in the frequency domain, and compares the at least one detected parameter with a threshold to determine whether or not the signal disturbance has occurred.

13. The apparatus for receiving a navigation signal of claim 10, further comprising:
a navigation message extractor extracting a navigation message from the navigation signal output from the first band pass filter; and
a signal disturbance determining unit determining whether the signal disturbance has occurred using information of the navigation message.

14. The apparatus for receiving a navigation signal of claim 10, further comprising
an adaptive analog to digital converter (ADC) converting the navigation signal output from the first band pass filter into a digital signal depending on a quantization bit,
wherein the controller controls the quantization bit depending on whether or not the signal disturbance has occurred.

15. The apparatus for receiving a navigation signal of claim 10, further comprising
a navigation solution calculator calculating a navigation solution from the navigation signal when it is determined that the signal disturbance has not occurred from the navigation signal output from the first band pass filter.

16. The apparatus for receiving a navigation signal of claim 10, wherein
the controller instructs the filter group unit to select the second band pass filter when a carrier to noise power density of the navigation signal output from the first band pass filter exceeds a predetermined threshold.
